(19) United States
(12) Patent Application Publication
(10) Pub. No.: US 2026/0113356 A1
(43) Pub. Date: Apr. 23, 2026

(54) ENDOGENOUS SECURITY PROTECTION METHOD FOR CONFIGURATION DATA IN OPERATING SYSTEM OF NETWORK NODE

(71) Applicant: ZHEJIANG LAB, Hangzhou, Zhejiang (CN)

(72) Inventors: Peilei WANG, Hangzhou, Zhejiang (CN); Ruyun ZHANG, Hangzhou, Zhejiang (CN); Tao ZOU, Hangzhou, Zhejiang (CN); Shunbin LI, Hangzhou, Zhejiang (CN); Peilong HUANG, Hangzhou, Zhejiang (CN); Hanguang LUO, Hangzhou, Zhejiang (CN)

(73) Assignee: ZHEJIANG LAB, Hangzhou, Zhejiang (CN)

(21) Appl. No.: 19/147,992

(22) PCT Filed: Jan. 30, 2024
(86) PCT No.: PCT/CN2024/074742

§ 371 Date: Jul. 14, 2025

(30) Foreign Application Priority Data
Nov. 8, 2023 (CN) 202311481291.6

(51) Int. Cl. H04L 9/40; G06F 11/1446; G06F 16/22

(52) U.S. Cl. CPC H04L 63/20; G06F 11/1464; G06F 16/2255; G06F 2201/80

(57) ABSTRACT

An endogenous security protection method for configuration data in an operating system of a network node includes: when a data backup module receives a network message flow, target configuration data is backed up in the data backup module, a distribution module send the received network message flow to each dynamic heterogeneous redundant executer respectively, each dynamic heterogeneous redundant executer stores the target configuration data, a synchronization module read the target configuration data stored by each dynamic heterogeneous redundant executer respectively, a judgment module performs consistency judgment, the synchronization module performs online-offline scheduling on the executers based on a judgment result, a target executer with data disorder is taken offline, a candidate executer is brought online, and the candidate executer obtains the target configuration data from the data backup module.

### CROSS-REFERENCE TO RELATED APPLICATIONS

This application is a national stage of International Application No. PCT/CN2024/074742, filed on Jan. 30, 2024, which claims priority to Chinese Patent Application No. 202311481291.6, filed on Nov. 8, 2023. Both of the aforementioned applications are hereby incorporated by reference in their entireties.

### TECHNICAL FIELD

The present disclosure relates to the technical field of network communication, and in particular, to an endogenous security protection method for configuration data in an operating system of a network node.

### BACKGROUND

In recent years, a white-box switch equipped with a Software for Open Networking in the Cloud (SONIC) system is widely used in scenarios such as data center, and the SONIC system uses a remote dictionary server (redis) database as a message hub, maintains configuration information input by a user through the redis database, and notifies each service container.

However, the redis database itself is not completely secure and trusted, and data in the redis database may be tampered with to cause data disorder, such as a remote code/command execution (REC) vulnerability, resulting in abnormal switch functions.

Based on this, the present disclosure provides an endogenous security protection method for configuration data in an operating system of a network node.

### SUMMARY

The present disclosure provides an endogenous security protection method for configuration data in an operating system of a network node, to partially solve the above problem of the related arts.

### The Present Disclosure Adopts the Following Technical Solutions:

The present disclosure provides an endogenous security protection method for configuration data in an operating system of a network node, performed by a white-box switch equipped with the network node operating system, including:
receiving a configuration command input by a user, and encapsulating the configuration command into a network message flow;
backing up and parsing the network message flow to obtain target configuration data, and backing up the target configuration data;
storing the target configuration data in each of dynamic heterogeneous redundant executers of the network node operating system;
reading the target configuration data stored in the each of the dynamic heterogeneous redundant executers, and performing consistency judgment on the target configuration data stored in the each of the dynamic heterogeneous redundant executers to determine a judgment result;
determining a target executer from the dynamic heterogeneous redundant executers according to the judgment result, taking offline the target executer and cleaning the target executer, and bringing online a candidate executer;
reading, by the brought-online candidate executer, the backed-up network message flow; to store the target configuration data parsed from the network message flow in the brought-online candidate executer; and
after the brought-online candidate executer stores the target configuration data, synchronizing the target configuration data stored in dynamic heterogeneous redundant executers in an online-state to the network node operating system, to cause the target configuration data take effect.

The present disclosure provides an endogenous security protection apparatus for configuration data in an operating system of a network node, applied in a target unit, and the target unit is pre-deployed in the network node operating system of a white-box switch:
the target unit includes a command line input module, a distribution module, a judgment module, a synchronization module, a data backup module, at least three dynamic heterogeneous redundant executers, and a candidate executer to be brought online;
the apparatus includes:
the command line input module, configured to, when receiving a configuration command input by a user, encapsulate the configuration command into a network message flow, and send the network message flow to the distribution module and the data backup module respectively;
the data back-up module, configured to, when receiving the network message flow, parse the network message flow to obtain target configuration data, and store the target configuration data in the data backup module;
the distribution module, configured to, when receiving the network message flow, send the network message flow to each of the dynamic heterogeneous redundant executers, generate a distribution success message when distribution succeeds, and send the distribution success message to the synchronization module;
a target configuration data storage module, configured to, when each of the dynamic heterogeneous redundant executers receives the network message flow, parse the network message flow to obtain the target configuration data, and store the target configuration data;
the synchronization module, configured to, when receiving the distribution success message, read the target configuration data stored in the dynamic heterogeneous redundant executers respectively, and send the target configuration data stored in the dynamic heterogeneous redundant executers to the judgment module;
the judgment module, configured to: when receiving the target configuration data respectively stored in the dynamic heterogeneous redundant executers, perform consistency judgment according to the target configuration data respectively stored in the dynamic heterogeneous redundant executers, determine a judgment result, and return the judgment result to the synchronization module;
an online-offline scheduling module, configured to, when the synchronization module receives the judgment result, determine a target executer from the dynamic heterogeneous redundant executers according to the judgment result, take offline the target executer and clean the target executer, and bring online the candidate executer to be brought online, where the brought-online candidate executer reads the network message flow from the data backup module, and the target configuration data parsed from the network message flow is stored in the brought-online candidate executer; and
a configuration data take effect module, configured to, when the brought-online candidate executer stores the target configuration data, cause the synchronization module to synchronize the target configuration data stored in dynamic heterogeneous redundant executers in an online-state to the network node operating system, to cause the target configuration data take effect.

The present disclosure provides a computer-readable storage medium, storing a computer program, where when the computer program is executed by a processor, the endogenous security protection method for configuration data in the network node operating system is implemented.

The present disclosure provides an electronic device, including a memory, a processor, and a computer program stored in the memory and executable by the processor, where the processor executes the computer program to implement the endogenous security protection method for configuration data in the network node operating system.

At least one technical solution adopted by the present disclosure can achieve the following beneficial effects:

According to an endogenous security protection method for configuration data in an operating system of a network node provided by the present disclosure, when a data backup module receives a network message flow, target configuration data is backed up in the data backup module, a distribution module sends the received network message flow to each dynamic heterogeneous redundant executer respectively, each dynamic heterogeneous redundant executer stores the target configuration data, a synchronization module reads the target configuration data stored by each dynamic heterogeneous redundant executer respectively, a judgment module performs consistency judgment, the synchronization module performs online-offline scheduling on the executers based on a judgment result, a target executer with data disorder is taken offline, a candidate executer is brought online, and the candidate executer obtains the target configuration data from the data backup module. The target configuration data is dynamically and redundantly backed up to the data backup module to dynamically protect the target data, so that the protection capability against known and unknown threats is realized, and the performance of endogenous security of the configuration data in the network node operating system is enhanced.

### BRIEF DESCRIPTION OF DRAWINGS

The drawings described herein are used to provide a further understanding of the present disclosure, constitute a part of the present disclosure, and the schematic embodiments of the present disclosure and the description thereof are used to describe the present disclosure, and do not constitute an improper limitation on the present disclosure. In the drawings:

FIG. 1 is a schematic diagram of a system for implementing an endogenous security protection method for configuration data in an operating system of a network node according to an embodiment of the present disclosure.

FIG. 2 is a schematic flowchart of an endogenous security protection method for configuration data in an operating system of a network node according to an embodiment of the present disclosure.

FIG. 3 is a schematic flowchart of an endogenous security protection method for configuration data in an operating system of a network node according to another embodiment of the present disclosure.

FIG. 4 is a schematic diagram of an endogenous security protection method for configuration data in an operating system of a network node according to another embodiment of the present disclosure.

FIG. 5 is a schematic diagram of an endogenous security protection apparatus for configuration data in an operating system of a network node according to an embodiment of the present disclosure.

FIG. 6 is a schematic diagram of an electronic device corresponding to FIG. 2.

### DETAILED DESCRIPTION

In order to make the objectives, technical solutions and advantages of the present disclosure clearer, the technical solutions of the present disclosure will be clearly and completely described below with reference to specific embodiments of the present disclosure and corresponding drawings. Obviously, the described embodiments are only some, but not all, embodiments of the present disclosure. Based on the embodiments in the present disclosure, all other embodiments obtained by those skilled in the art without making creative efforts fall within the protection scope of the present disclosure.

In addition, it should be noted that all actions of acquiring signals, information or data in the present disclosure are performed under the premise of complying with the corresponding data protection regulation policy of the location and obtaining authorization given by the corresponding device owner.

It should be noted that features in the following embodiments and implementations may be combined with each other on a non-conflict basis.

The technical solutions provided by the embodiments of the present disclosure are described in detail below with reference to the accompanying drawings.

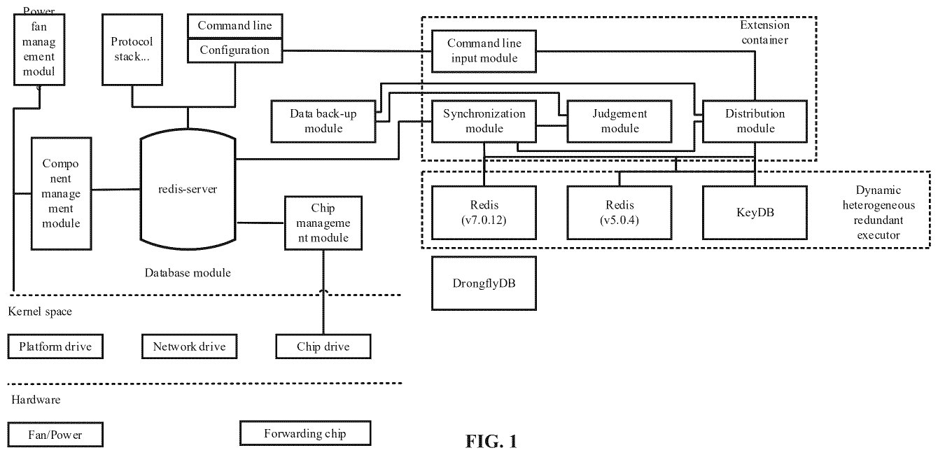

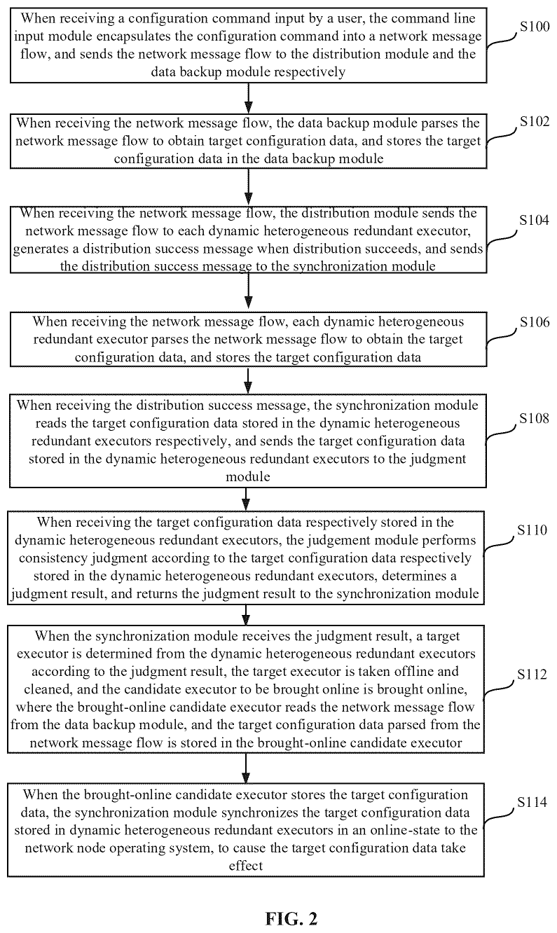

In the present disclosure, a schematic diagram of an overall architecture of an operating system of a network node of a white-box switch is shown in FIG. 1. The present disclosure describes specific technical solutions by taking the network node operating system being a SONIC system as an example. The white-box switch equipped with the SONIC system is deployed with a target unit therein, where the target unit specifically includes a command line input module, a distribution module, a judgment module, a synchronization module, a data backup module, and at least three dynamic heterogeneous redundant executers (three dynamic heterogeneous redundant executers in FIG. 2, which are a redis (v.7.0.12) database, a redis (v.5.0.4) database, and a KeyDB database): in addition, the target unit further includes a candidate executer (DrongflyDB database) to be brought online, and the candidate executer is heterogeneous with the at least three dynamic heterogeneous redundant executers.

As shown in FIG. 1, the command line input module, the synchronization module, the judgment module and the distribution module are deployed in a same extension container, and these four modules run independently in a process form. The three online dynamic heterogeneous redundant executers and an offline candidate executer also run on the SONIC system in a container form. The data backup module runs in an independent process due to its high reliability requirement.

A manner of pre-deploying the command line input module, the distribution module, the judgment module, the synchronization module and the data backup module may include following two deployment manners.

Manner 1: a specified source code is integrated into a source code of an open networking operating system of a white-box switch in advance, the integrated source code is compiled to obtain an image container, the image container is installed in the white-box switch, and after the white-box switch is powered on and started, an extension container corresponding to the image container is run in an operating system of a network node (SONIC system) running the white-box switch, where the command line input module, the synchronization module, the judgment module, and the distribution module are deployed in the extension container. The specified source code is used for deploying the command line input module, the synchronization module, the judgment module and the distribution module, and the present disclosure does not limit whether the specified source code is automatically generated or manually configured.

Manner 2: a developed extension container is published as an image container in advance, and after the white-box switch is powered on and started, the image container is loaded into an operating system of a network node of the white-box switch, where the command line input module, the synchronization module, the judgment module, and the distribution module are deployed in the extension container.

### The Operation of the Extension Container in the SONIC System in the Manner 1 Mainly Includes Following Three Steps:

step 1: adding an mk file of the extension container to a rules directory, where the mk file is used to declare makefile variable information such as a source code path of the extension container;
step 2: adding a source code of the extension container to a src directory, where a directory of the source code is consistent with the source code path declared in step 1;
step 3: adding a Dockerfile file and a supervisord file of an extension container in a docker directory, where the supervisord file is used to manage processes in the extension container, that is, processes respectively corresponding to the command line input module, the synchronization module, the judgement module, and the distribution module; and the Dokerfile file is used to construct the extension container, including compiling the source code in step 2.

In addition, in an embodiment of the present disclosure, when the data backup module is deployed, an independent process may be used to enable the data backup module to independently run in the SONIC system. Certainly, in a higher-security-requirement scenario, the data backup module may run on an external FPGA (Field Programmable Gate Array) daughter card or another server, and when the data backup module needs to interact with another process (such as the dynamic heterogeneous redundant executer, the command line input module, or the like), security of the data transmission link may be ensured in an encryption transmission manner.

FIG. 2 is a schematic flowchart of an endogenous security protection method for configuration data in an operating system of a network node provided by the present disclosure. The method includes following steps S100 to S114.
S100: when receiving a configuration command input by a user, the command line input module encapsulates the configuration command into a network message flow, and sends the network message flow to the distribution module and the data backup module respectively.

In the embodiments of the present disclosure. ACL (access control list) configuration data is taken as target configuration data to be protected. In SONIC, the ACL configuration can take effect by directly writing into a database 4 of system native redis, and no other management operation is required. However, for data complex to be managed, for example, bgp configuration, a management module of a bgpmgr-orchagent needs to be added, and the management module of the bgpmgr-orchagent may be implemented with reference to a corresponding submodule in a swss module in SONIC native code. Thus, in the embodiments of the present disclosure, it is taken as an example that ACL configuration data simpler to be managed (which also means a greater risk of being attacked and tampered) is taken as the target configuration data to be protected, and a specific technical solution will be described.

The command line input module is extended based on the source code of the SONIC system, and in the embodiments of the present disclosure, a native ACL command is extended according to an ACL function of the white-box switch, to reinforce security of ACL configuration data configured by a user.

In practice, the ACL command is usually written directly to the database 4 of the redis server of the SONIC. In the embodiments of the present disclosure, a patch file manner is used to extend the main.py file of the source code, to extend the ACL.

In fact, different command line input modules may be implemented by using different patch files. Similarly, the distribution module, the judgment module, the redundant executer may also be synchronously matched in code version with the command line input module. Based on this, different function configuration data of the network node operating system can be reinforced.

For example, if user A only needs to reinforce ACL configuration data, based on this solution, user A only needs to be provided with ACL-related code packets: if user B needs to reinforce multiple configuration data such as ACL and VLAN, then user B needs to be provided with code packets related to both ACL and VLAN.

Specifically, in the main.py, encapsulation of the addition command for the ACL TABLE is presented in about line 3361 of the source code, and the encapsulation of the ACL RULE command is added behind the above code, and the command is first described by the following code:

@add.command( )
@click.argument(“rule_name”, metavar=“<rule_name>”)
@click.option(“-p”, “--priority”)
...

The above code is used to describe parameters of the ACL RULE command, where the “−p” in line 3 represents that a priority parameter needs to be set in the command line. In practice, the command of ACL RULE is as follows:

“sudo config acl add rule DATAACL1: RRLE_1-p 9999-a FORWARD SRC_IP 10.0.0.2/32” (DATAACL1 represents the acl table name, RRLE_1 represents the rule name connected with colon “:”,−p represents PRIORITY, −a represents PACKET_ACTION).

After completing the above command description, specific execution parameters of the command are continued to be developed, and in the embodiments of the present disclosure, the command execution parameters only complete the following two tasks:
1. parameters input by the command line are encapsulated into a character string, where the character string is an encapsulated network message flow;
2, the character string (network message flow) is sent to the distribution module through a socket interface.

The encapsulation code of the character string is as follows:

```
message = f‘HMSET ACL_RULE|{rule_name.replace(“:”, “|”)}’
if priority:
  message = f‘{message} PRIORITY {priority}’
if action:
  message = f‘{message} PACKET_ACTION {action}’
...
```

A format string technique in python is adopted herein, and the finally formed to-be-sent string is “HMSET ACL_RULE|DATAACL1:RULE_1 PRIORITY 9999 PACKET_ACTION FORWARD SRC_IP 10.0.0.2/32”.

The character string (network message flow) is sent to the distribution module through a socket interface, where specific code is as follows:

client_socket = socket.socket(socket.AF_INET,
socket.SOCK_STREAM)
client_socket.connect((‘127.0.0.1’, 6666))
client_socket.send(message.encode( ))
...

That is, through a 6666 port of the local TCP (Transmission Control Protocol), the command line input module sends the network message flow to the distribution module and the data backup module respectively. The distribution module and the data backup module respectively run a TCP server to receive the message, and port numbers corresponding to the bound ports are 6666 and 6667 respectively.
S102: when receiving the network message flow, the data backup module parses the network message flow to obtain target configuration data, and stores the target configuration data in the data backup module.

In the embodiment of the present disclosure, the data backup module adopts a C-S (client-server) architecture, the data backup module itself serves as a server, and the judgment module and the distribution module interacting with the data backup module serve as clients.

In the embodiment of the present disclosure, the data backup module is implemented in C language and includes only two C language source files, one is memory_db.c, and the other is data_backup_server.c. The source file memory_db.c implements a lightweight memory database, provides interfaces such as db_open, db_close, db_store, and db_get, and compiles the interfaces into a library file; and the source file data_backup_server.c is linked to the library generated by compiling the memory_db.c, generates an executable program as a main process of the data backup module, receives an interaction request from the client in the main process, and then calls an interface such as db_open to read or update data.

For example, when the TCP server in the main process receives data of “HMSET ACL_RULE|DATAACL1:RULE_1 PRIORITY 9999 PACKET_ACTION FORWARD SRC_IP 10.0.0.2/32”, a database named “ACL” is created through db_open, then the key is set to “ACL_RULE|DATAACL1:RULE_1”, the value is set to “PRIORITY 9999 PACKET_ACTION FORWARD SRC_IP 10.0.0.2/32”, and the data is stored.
S104: when receiving the network message flow, the distribution module sends the network message flow to each dynamic heterogeneous redundant executer, generates a distribution success message when distribution succeeds, and sends the distribution success message to the synchronization module.

The distribution module completes three tasks, one of the tasks is that, the distribution module serves as the TCP server, and monitors the message sent by the command line input module.

After receiving the message, the distribution module needs to call an interface of each dynamic heterogeneous executer to distribute the data. In the embodiments of the present disclosure, the dynamic heterogeneous executers are redis, dragonflydb and keydb of different versions, respectively, where the interactive interface of the redis database is implemented by hiredis. The dragonflydb and keydb also have corresponding existing types of interactive interfaces.

In fact, both the dragonflydb and keydb are compatible with a hiredis interface, and data interaction can be implemented through hiredis.

Finally, the distribution module sends the distribution success message to the synchronization module, and in this case, the distribution module, as the TCP client, forwards, to the TCP server in the main process of the synchronization module, a message sent by the command line input module, to notify the synchronization module that a new configuration command is distributed, to trigger synchronization logic.
S106: when receiving the network message flow, each dynamic heterogeneous redundant executer parses the network message flow to obtain the target configuration data, and stores the target configuration data.

Specifically, the distribution module calls the hiredis interface to directly communicate with each dynamic heterogeneous redundant executer. The dynamic heterogeneous redundant executers in this embodiment are databases such as redis, and different dynamic heterogeneous redundant executers correspond to different versions of databases. The different versions may be redis, dragonflydb, and keydb. When each dynamic heterogeneous redundant executer stores the target configuration data, the target configuration data is stored in a key-value form.
S108: when receiving the distribution success message, the synchronization module reads the target configuration data stored in the dynamic heterogeneous redundant executers respectively, and sends the target configuration data stored in the dynamic heterogeneous redundant executers to the judgment module.

The purpose of data synchronization is to continuously acquire data from multiple dynamic heterogeneous redundant executers for comparison and write back to the network node operating system. In order to facilitate synchronization, all keys that need to be reinforced for security are stored in the synchronization module, which is implemented through a linked list of C language (only keys are stored, and no value is stored).

For example, based on the above command line operation, the synchronization module will store the key “ACL_RULE|DATAACL1:RULE_1” into the linked list: if the user newly sets RULE2, the synchronization module will also add “ACL_RULE|DATAACL1:RULE_2” into the linked list.

When receiving the message related to the key “ACL_RULE|DATAACL1:RULE_1” from the distribution module, the synchronization module triggers the event synchronization logic, and at this time, the synchronization module reads the target configuration data, that is, the value corresponding to the above key, from the multiple heterogeneous executers, and delivers the target configuration data to the judgement module for consistency judgement.

In addition to event-triggered synchronization actions, the synchronization module also performs periodical-event-triggered synchronization actions. Specifically, in the embodiment of the present disclosure, the synchronization period is set to 5 min, and when the synchronization period is reached, the synchronization module sequentially obtains the key information from the key linked list, and then reads the target configuration data from the multiple dynamic heterogeneous redundant executers based on the key information.
S110: when receiving the target configuration data respectively stored in the dynamic heterogeneous redundant executers, the judgement module performs consistency judgment according to the target configuration data respectively stored in the dynamic heterogeneous redundant executers, determines a judgment result, and returns the judgment result to the synchronization module.

In the present disclosure, when the judgment module performs consistency judgment based on the target configuration data extracted from each dynamic heterogeneous redundant executer, an adopted judgment manner may be any existing judgment manner, which is not limited in the present disclosure.

Generally, the judgment process adopts a manner of “majority rules”, and if there is target configuration data stored in a certain dynamic heterogeneous redundant executer, among the target configuration data stored in the dynamic heterogeneous redundant executers, different from target configuration data stored in other dynamic heterogeneous redundant executers, it indicates that the target configuration data stored in this dynamic heterogeneous redundant executer may have a problem of data disorder. The judgement result may indicate which dynamic heterogeneous redundant executer stores target configuration data inconsistent with target configuration data stored by most other dynamic heterogeneous redundant executers.

For example, for a same data key, if a value obtained from a dynamic heterogeneous redundant executer A and a dynamic heterogeneous redundant executer B is “value1”, and a value obtained from a dynamic heterogeneous redundant executer C is “value2”, it is determined that the dynamic heterogeneous redundant executer C stores the target configuration data inconsistent with those in other dynamic heterogeneous redundant executers, and the dynamic heterogeneous redundant executer C is taken offline to be processed. If data obtained from the three dynamic heterogeneous redundant executers are all inconsistent with each other, the three dynamic heterogeneous redundant executers are all taken offline.

The above manner may lead to frequent online-offline shift of the dynamic heterogeneous redundant executers, and therefore is not necessarily applicable to most scenarios that requires judgement, but as the data backup module has high security and the executers are relatively simple, the above solution is adopted.
S112: when the synchronization module receives the judgment result, a target executer is determined from the dynamic heterogeneous redundant executers according to the judgment result, the target executer is taken offline and cleaned, and the candidate executer to be brought online is brought online, where the brought-online candidate executer reads the network message flow from the data backup module, and the target configuration data parsed from the network message flow is stored in the brought-online candidate executer.

In the embodiment of the present disclosure, trust of the newly brought-online executer is essentially trust of the data backup module in the present disclosure, so as implement initialization of the newly brought-online executer by trusting the target configuration data in the data backup module.

For the online and offline operations of the executer, since the executer in the embodiments of the present disclosure is a database server such as redis, the database may be directly taken offline through a shutdown command. Meanwhile, a rdb file may be generated based on the data backup module, and based on a format of the rdb file, the synchronization module may generate the rdb file after obtaining the target configuration data from the data backup module, where the format of the rdb file may be obtained through redis-related data. Then, online initialization of the redis database can be completed through the rdb file. The online and offline operations of other executers such as keydb are similar to that of the redis executer.

In an optional embodiment of the present disclosure, since a source of the target configuration data in the newly brought-online heterogeneous redundant executer (candidate executer) is the data backup module, and the target configuration data in the data backup module has high security and high reliability, the target configuration data stored in the newly brought-online heterogeneous redundant executer is generally trusted, and therefore, an online protection period is set for the newly brought-online heterogeneous redundant executers, and in the online protection period, the target configuration data stored in the newly brought-online heterogeneous redundant executer is trusted, and when consistency judgment is performed again on the target configuration data respectively stored in the plurality of dynamic heterogeneous redundant executers when the newly brought-online executer is within the online protection period, in a case that a judgment result represents that the target configuration data stored in the heterogeneous redundant executer within the online protection period is inconsistent with the target configuration data stored in other heterogeneous redundant executers, it is considered that the target configuration data stored in the other heterogeneous redundant executers is disordered, and at this time, it is believed that the target configuration data stored in the heterogeneous redundant executer within the online protection period is reliable and accurate, rather than based on the manner of “majority rules”.

Specifically, after the brought-online candidate executer stores the target configuration data parsed from the network message flow; for each non-offline dynamic heterogeneous redundant executer, it is determined whether the target configuration data stored in the non-offline dynamic heterogeneous redundant executer is consistent with the target configuration data stored in the candidate executer within the online protection period, where the non-offline dynamic heterogeneous redundant executer is not in the online protection period.

If not consistent, the non-offline dynamic heterogeneous redundant executer is taken offline.

If consistent, no action is taken.

In addition, an executer not within the online protection period and inconsistent with other executers according to the judgement result is also taken offline.
S114: when the candidate executer stores the target configuration data, the synchronization module synchronizes the target configuration data stored in dynamic heterogeneous redundant executers in an online-state to the network node operating system, to cause the target configuration data take effect.

After the judgment is completed, a running state of the configuration corresponding to the key is read from the network node operating system, and if the running state is inconsistent with the judgment result, the judgment result is rewritten into the network node operating system, to cause the configuration to take effect.

In the process of causing the configuration to take effect, in the embodiment of the present disclosure, a native redis database writing interface of the network node operating system can be directly called, the ACL configuration information is written into a number 4 database, and the configuration can take effect: reading of the running state can be implemented by calling the native redis database reading interface of the network node operating system.

Specifically, in the embodiment of the present disclosure, the synchronization module also stores a key space, and the key space is a subset of a key space in the redis database of the switch native operating system, and is used to store a key related to a configuration command, obtained from the command line input module, requiring protection reinforcement.

In the embodiment of the present disclosure, the synchronization action is carried out in a key-by-key manner in sequence: after the synchronization action between heterogeneous executers of a piece of key-value data is completed, the synchronization module obtains data from the database of the native switch network operating system (or obtains a state of the native switch through a show command), and compares the obtained data with the synchronized data; and if the data are inconsistent, the synchronization module synchronizes data related to a protection and reinforcement configuration command into the switch native network operating system through a database writing command or related switch configuration commands, to cause the data to take effect.

Specifically, if ACL configuration in the native switch operating system is inconsistent with the ACL configuration stored in the heterogeneous executer, it may be directly completed by a writing database operation: if vlan configuration in the native switch operating system is inconsistent with that stored in the heterogeneous executer, a vlan config interface needs to be called to refresh the vlan configuration. Other commands are similar to the above two cases.

According to an endogenous security protection method for configuration data in an operating system of a network node provided by the present disclosure, when a data backup module receives a network message flow, target configuration data is backed up in the data backup module, a distribution module sends the received network message flow to each dynamic heterogeneous redundant executer respectively, each dynamic heterogeneous redundant executer stores the target configuration data, a synchronization module reads the target configuration data stored by each dynamic heterogeneous redundant executer respectively, a judgment module performs consistency judgment, the synchronization module performs online-offline scheduling on the executers based on a judgment result, a target executer with data disorder is taken offline, a candidate executer is brought online, and the candidate executer obtains the target configuration data from the data backup module.

The target configuration data is backed up to the data backup module to dynamically protect the target data, so that the protection capability against known and unknown threats is realized, and the performance of endogenous security of the configuration data in the network node operating system is enhanced.

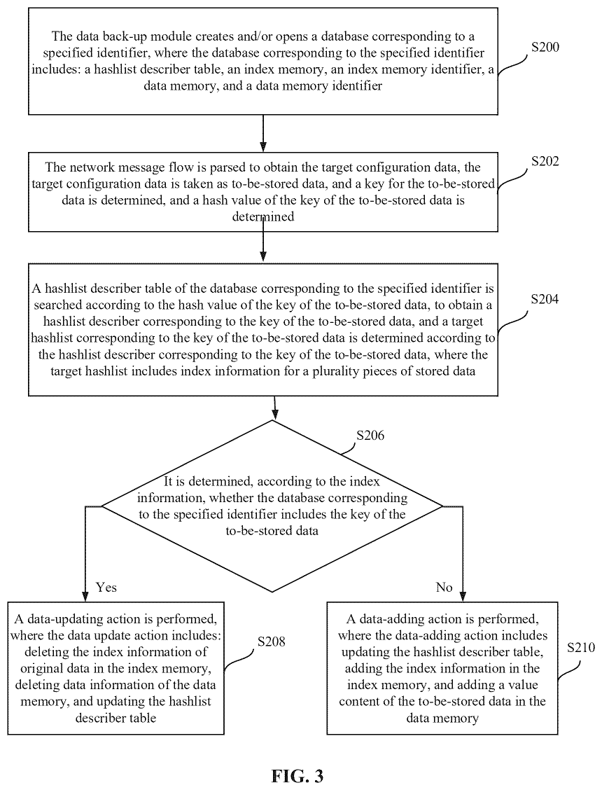

In one or more embodiments of the present disclosure, in S104, the data backup module parses the network message flow to obtain the target configuration data, and stores the target configuration data in the data backup module, which may be specifically implemented through the following steps S200 to S210, as shown in FIG. 3.
S200: the data back-up module creates and/or opens a database corresponding to a specified identifier, where the database corresponding to the specified identifier includes: a hashlist describer table, an index memory, an index memory identifier, a data memory, and a data memory identifier.

In the embodiments of the present disclosure, creation of the database corresponding to the specified identifier is implemented by instantiating a DB structure based on an object-oriented programming concept, where the DB structure is defined as follows:

```
typedef struct {
  char *name;
  int *hashlist_describer_table;
  UINT8 *idxmem;
UINT8 *datmem;
  int idxmem_cursor;
  int datmem_cursor;
  UINT8 hashtable_size;
} DB;
```

### Specific Description for the Items are as Follows:

Item 1: name represents an identifier of a database, used to identify a created database.
Item 2: hashlist_describer_table represents a hashlist describer table, each item in the table is an int-type value, and the value describes a location of a first item of each hashlist in an index memory (that is, idxmem).
Item 3: idxmem represents an index memory, storing a plurality pieces of index information, and a structure definition of the index information is described below.
Item 4: datmem represents a data memory, storing data value information.
Item 5: idxmem_cursor represents an index memory identifier, and in the embodiments of the present disclosure, a value of this item always corresponds to an end position of occupied memory in idxmem.
Item 6: datmem_cursor represents a data memory identifier, and in the embodiments of the present disclosure, a value of this item always corresponds to an end position of occupied memory in datmem.
Item 7: hashtable_size represents a number of database hashlists, that is, a size of the hashlist describer table hashlist describer table.

### The Index Information Stored in the Idxmem is Defined by the Following Structure:

typedef struct {
int next_idxmsg_describer;
int data_len;
int data_position;
int key_len;
char key[0];
} STRUCT_idxmsg;

### Specific Description for the Items are as Follows:

Item 1: next_idxmsg_decriber records a position of, in idxmem, a next item of the hashlist where the current index information is located;
Item 2: data_len records a length of, in datmem, a data value corresponding to the current index information;
Item 3: data position records a position of, in datmem, a data value corresponding to the current index information;
Item 4: key_len records a length of a data key corresponding to the current index information;
Item 5: key records content of a data key corresponding to the current index information.

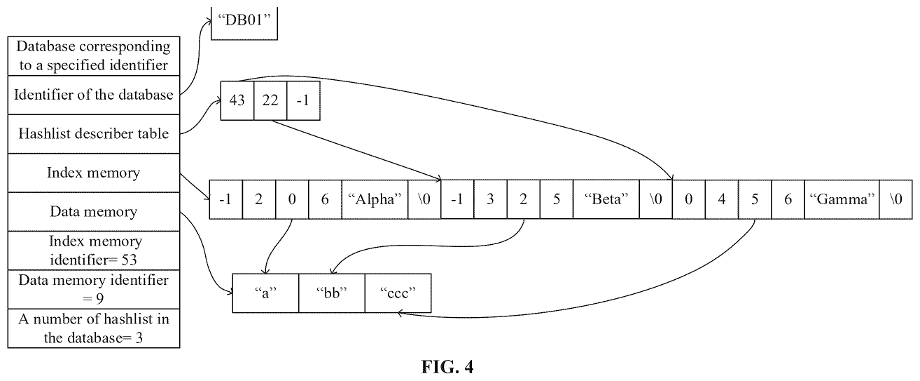

Specifically, referring to FIG. 4. FIG. 4 shows an example of a database state where three pairs of key-value data are stored, and the stored data are {“Alpha”, “a”}, {“Beta”, “bb”}, and {“Gamma”, “ccc”} respectively.

In the example shown in FIG. 4, hashtable_size takes a value of 3, that is, up to three hashlists, but there are only two valid describers in the actual hashlist_describer table, and a third describer takes a value of −1, which indicates that a third hashlist is empty. A describer of the hashlist_describer_table represents a position of a first item of the corresponding hashlist in idxmem, for example, a describer value of hashlist #0 (hash values of corresponding keys are all 0) is 25, representing that the position of the first item of the hashlist is 25, that is, the index information corresponding to the “Gamma” key: meanwhile, there are two items on the hashlist #0, and a value of a first element in the first item (next_idxmsg_describer item in the structure of STRUCT_idxmsg) is 0, representing that the position of the next item of the current hashlist #0 in idxmem is 0, that is, the index information corresponding to the “Alpha” key. A third element in the index information (data_position item in the STRUCTCT_idxmsg structure) represents a position of the value corresponding to the key in datmem, for example, the value of the data_position item in the index information corresponding to the “Gamma” key is 5, that is, a position of the value “ccc” corresponding to the “Gamma” key in datmem is 5.
S202: the network message flow is parsed to obtain the target configuration data, the target configuration data is taken as to-be-stored data, and a key for the to-be-stored data is determined, and a hash value of the key of the to-be-stored data is determined.

In the embodiments of the present disclosure, calculation of the hash value is completed through the following three lines of codes:

$$\begin{matrix}for ( i = 1 ; ( c = {}^{*} key ++ ) != 0 ; i + + ) \\ hval += {c}^{*} i ; \\ return ( hval \% db -> hashtable\_size ) ;\end{matrix}$$

the above is a commonly used hash manner for a character string. According to the above method, in an example shown in FIG. 4, hash values of keys “Alpha” and “Gamma” are 0, and a hash value of the key “Beta” is 1.
S204: a hashlist describer table of the database corresponding to the specified identifier is searched according to the hash value of the key of the to-be-stored data, to obtain a hashlist describer corresponding to the key of the to-be-stored data, and a target hashlist corresponding to the key of the to-be-stored data is determined according to the hashlist describer corresponding to the key of the to-be-stored data, where the target hashlist includes index information for a plurality pieces of stored data.
S206: it is determined, according to the index information, whether the database corresponding to the specified identifier includes the key of the to-be-stored data. If the database includes the key of the to-be-stored data, step S208 is performed: otherwise, step S210 is performed.

First step: determining a location of a first item of the target hashlist in the index memory according to the hashlist describer corresponding to the key of the to-be-stored data; where the target hashlist includes index information for a plurality pieces of stored data, and the index information includes a location of a next piece of stored data of each piece of stored data in the target hashlist in the index memory, a length of a value of each piece of stored data, a location of the value of each piece of stored data in the data memory, a length of a key of each piece of stored data, and content of the key of each piece of stored data.

First, a hashlist describer corresponding to the key of the to-be-stored data is obtained from the hashlist describer table corresponding to the key of the to-be-stored data still according to the calculated hash value of the key of the to-be-stored data.

Still referring to the example shown in FIG. 4, to obtain data of the key “Alpha”, a hash value of the character string “Alpha” is first calculated, and according to the above hash algorithm in the embodiments of the present disclosure, the value is calculated as 0.

Obtaining the hashlist describer according to the hash value can be directly implemented by an operation of selecting a value of a memory pointed by a pointer through C language, and a specific code example is as follows:

$$int hashlist\_describer = {}^{*} ( db -> hashlist\_describer \_table + hashval ) ;$$

through the above code, the hashlist describer corresponding to the key “Alpha” can be obtained.

Further, in this embodiment of the present disclosure, the index memory idxmem is actually a data structure of a compressed set, and an item in the set is the index information, which is defined by a structure STRUCT_idxmsg. The structure includes a location of a next item of the hashlist in the index memory (next_idxmsg_describer), a length of a value of the stored data (data_len), a location of the value of the stored data in the data memory (data_position), a length of a key of the stored data (key_len), and content of the key of the stored data (key).

In the DB structure, idxmem is defined as UINT8* type (i.e., char type in C language), and when specific index information in the idxmem is to be processed, a forced pointer type can be converted into the STRUCT_idxmsg* type, at this time, key content can be directly accessed through a key[0] item, and the key[0] does not occupy any size of sizeof in the STRUCT_idxmsg. This solution refers to a development manner of the Ethernet communication protocol stack, and the STRUCT_idxmsg structure is equivalent to a header of the index information, so that the index information can be processed with extremely high efficiency.

Still referring to the example shown in FIG. 4, after obtaining that the value of the hashlist describer hashlist_describer is 44, it indicates that the position of the first item of the corresponding hashlist in idxmem is 44, and in such way, first piece of index information in the hashlist can be obtained:

$${STRUCT\_idxmsg}^{*} i d x m s g = ( {STRUCT\_idxmsg}^{*} ) ( db -> idxmem + hashlist\_describer ) ;$$

through the above code, the idxmsg includes the first index information in the obtained hashlist.

Second step: traversing the index information of each piece of stored data included in the target hashlist, for the index information of each piece of stored data in the target hashlist, comparing content of a key of the piece of stored data in the index information of the piece of stored data with content of the key of the to-be-stored data.

### Codes for the Traversing Process is as Follows:

while (idxmsg->next_idxmsg_describer >=0) {
if (strcmp(idxmsg->key ,key) == 0)
return (idxmsg);
idxmsg = (STRUCT_idxmsg *)(db->idxmem +
next_idxmsg_describer) ;
}

When it is determined that content of the stored key is consistent with content of the to-be-stored key, an idxmsg pointer is returned, and index information corresponding to the key “Alpha” is stored in the STRUCT_idxmsg structure pointed by the pointer.

When the to-be-stored key does not exist, the above step returns an empty pointer.

Third step: when the index information of the plurality pieces of stored data included in the target hashlist includes a key of stored data having same content with the key of the to-be-stored data, determining the database corresponding to the specified identifier includes the key of the to-be-stored data.

Fourth step: when the index information of the plurality pieces of stored data included in the target hashlist does not include a key of stored data having same content with the key of the to-be-stored data, determining the database corresponding to the specified identifier does not include the key of the to-be-stored data.
S208: a data-updating action is performed, where the data update action includes: deleting the index information of original data in the index memory, deleting data information of the data memory, and updating the hashlist describer table.

If the key of the to-be-stored data exists in the database corresponding to the specified identifier, it indicates that a value corresponding to the key of the to-be-stored data exists in the database corresponding to the specified identifier, and the value may be same as or different from the value of the to-be-stored data. Since all data stored in the database corresponding to the specified identifier needs to be backed up by the data backup module, to ensure authenticity and reliability of the data, in this step, an original value (not the value of the to-be-stored data) in the database corresponding to the specified identifier corresponding to the key of the to-be-stored data needs to be deleted, and after the deletion, the value of the to-be-stored data is stored in the database corresponding to the specified identifier, to implement storing the target data (the to-be-stored data) in the database corresponding to the specified identifier.

### An Optional Data-Updating Action is as Follows:

First step: taking stored data corresponding to a key of the stored data same as the key of the to-be-stored data in the database corresponding to the specified identifier as to-be-deleted data.
Second step: obtaining index information of the to-be-deleted data, determining a location of the index information of the to-be-deleted data in the target hashlist, and determining, according to the location of the index information of the to-be-deleted data in the target hashlist, whether the index information of the to-be-deleted data is located in a first item of the target hashlist.

In the embodiments of the present disclosure, the deletion action is implemented by calling a _db_del static function, as described above, the function is equivalent to a member function of the DB object, and is defined as follows:

$$static int\_db \_del ( {DB}^{*} , const {STRUCT\_idxmsg}^{*} , int ) ;$$

A second parameter is actually the obtained index information of the to-be-deleted data, and a manner of obtaining the index information of the to-be-deleted data is similar to that in the above S204 and S206, and details will not be repeated herein.

Third step: when the index information of the to-be-deleted data is located in the first item of the target hashlist, updating index information of a next piece of stored data of the index information of the to-be-deleted data in the target hashlist into the hashlist describer table.

### The Above Steps are Implemented by Following Codes:

$${}^{*} ( db -> hashlist\_describer \_table + hashval ) = del\_key \_idxmsg -> next\_idxmsg \_describer ;$$

thus, the describer in the hashlist describer table can be updated.

Fourth step: when the index information of the to-be-deleted data is located in a non-first item of the target hashlist, removing the index information of the to-be-deleted data from the target hashlist.

The deletion step is implemented by using a while loop, and elements on the hashlist are traversed through the loop, so as to find a previous item of hash information of the hashlist to which the index information corresponding to the to-be-deleted key belongs, so that the next_idxmsg_desiber of the previous item can be assigned to the next_idxmsg_desiber of the current to-be-deleted index information, and the removal operation can be implemented.

Fifth step: traversing the hashlist describer table, and updating describer information in the hashlist describer table to new describer information after data deletion.

Data of the hashlist describer table needs to be correspondingly updated due to deletion of the key, and a manner adopted by the embodiment of the present disclosure is to compare a value of each describer with the position of the to-be-deleted key in idxmem, and when the value of each describer is smaller than the position of the to-be-deleted key in idxmem, the value of each describer is retained, otherwise, the value of each describer is subtracted by the length of the index information corresponding to the to-be-deleted key.

Specifically, FIG. 4 shows an example. There are two valid values in the current hashlist describer table, which are 44 and 22 respectively, assuming that the key “Alpha” is to be deleted, a length of the index information corresponding to the key “Alpha” is 22, and int del_key_idxmsg_size=sizeof(STRUCT_idxmsg)+strlen(del_key_idxmsg—: the position of the key “Alpha” in idxmem is 0, then since both 44 and 22 are greater than 0, both of which need to be subtracted by 22, that is, when the operation is completed, the value in the hashlist describer table is [22, 0, −1].

Sixth step: traversing each hashlist table, and updating location information of a next item of each item in the hashlist table in the index memory to new location information after data deletion.

This step is to update information of each idxmsg-, and the process is similar to that in the fifth step described above, and details will not be repeated herein.

Seventh step: locating a deletion start node and a deletion end node of the index memory and the data memory respectively.

The above steps only update the value of each index information in the idxmem, and do not actually delete the index information and the data information.

### The Following Code is Adopted:

$$int idxmem\_delete \_start = del\_key \_idxmsg - db -> idxmem ;$$

$$int idxmem\_delete \_end = idxmem\_delete \_start + del\_key \_idxmsg \_size ;$$

$$int datmem\_delete \_start = del\_key \_idxmsg -> data\_position ;$$

$$int datmem\_delete \_end = del\_key \_idxmsg -> data\_position + del\_key \_idxmsg -> data\_len ;$$

therefore, a start point and an end point of the to-be-deleted part in the idxmem and the datmem can be located.

Eighth step: creating a temporary memory buffer, where the temporary memory buffer is configured to store original data in the index memory and the data memory respectively, and writing data, from which corresponding segments are deleted, back to the index memory and the data memory of the database respectively based on the deletion start node and the deletion end node.

The above operations are implemented through a memncpy function, and a copy process may be implemented by using a commonly used method in the art, and details will not be described herein.

It can be seen from the above steps that, in the data backup process corresponding to the solution of the present disclosure, elements such as a hashlist describer table, an index memory, a data memory, index information, an index memory identifier, and a data memory identifier are introduced, with reference to implementation manners such as GDT and IDT for linux memory management, and also with reference to an Ethernet protocol stack implementation method, a backup process for non-relational key-value data is efficiently implemented by using a powerful pointer processing function of C language with an object-oriented programming concept. The whole backup sub-steps are easy to be maintained and transplanted, the data backup process can be traced, and very strong flexibility is provided for deployment and operation of the data backup module on different platforms.
S210: a data-adding action is performed, where the data-adding action includes updating the hashlist describer table, adding the index information in the index memory, and adding a value content of the to-be-stored data in the data memory.

If the key of the to-be-stored data does not exist in the database corresponding to the specified identifier, the key of the to-be-stored data and the value of the to-be-stored data need to be stored in the database corresponding to the specified identifier, so that the target data (the to-be-stored data) can be stored in the database corresponding to the specified identifier in a key-value form. Thus, in this step, a data-adding action is performed.

### An Optional Data-Adding Action is as Follows:

First step: determining, according to the hashlist describer corresponding to the key of the to-be-stored data, a target location of a first item of the target hashlist corresponding to the key of the to-be-stored data in the index memory.

An end position of the index memory is located by using the index memory identifier, which is implemented by using the following code:

$$STRUCT\_idxmsg idxmsg = ( {STRUCT\_idxmsg}^{*} ) ( db -> idxmem + db -> idxmem\_cursor ) ;$$

the idxmem_cursor represents a state variable, that is, an end position of valid data in the idxmem memory of the current database. Although the embodiments of the present disclosure are developed in C language, the object-oriented programming concept is taking as a reference. An example of the DB structure is an object: idxmem_cursor or the like in the object may be considered as a member variable of the object; and static functions _db_hash, _db_add, and _db_del related to the DB structure may be considered as member functions.

Further, according to the hashlist describer corresponding to the key of the to-be-stored data, a target location of the first item of the hashlist corresponding to the key of the to-be-stored data in the index memory can be determined through C language pointer operation, that is, *(db→hashlist_describer_table+hashval).

Second step: creating a specified index information hashlist item, and inserting the specified index information hashlist item before the first item of the target hashlist.

In this step, after the newly created hashlist item of the specified index information is inserted into the target hashlist, the position of the hashlist item of the specified index information in the target hashlist is the first item, the original first item in the target hashlist is set as a next item of the new first item, and so on.

### Information Update is Implemented Through Following Codes:

$$idxmsg -> next\_idxmsg \_describer = {}^{*} ( db -> hashlist\_describer \_table + hashval ) ;$$

$${}^{*} ( db -> hashlist\_describer \_table + hashval ) = db -> idxmem\_cursor = new\_idxmem \_cursor ;$$

in the above two code lines, the first line sets the first item of the original hashlist as a next item of the new first entry; and the second line synchronously updates values of the idxmem_cursor variable together.

Third step: obtaining a location of the value of the to-be-stored data in the data memory according to the data memory identifier.

Fourth step: updating a length of the value of the to-be-stored data, a position of the value of the to-be-stored data in the data memory, a length of the key of the to-be-stored data, and content of the key of the to-be-stored data into the specified index information hashlist item.

### The Above Steps May be Implemented by Following Codes:

$$\begin{matrix}idxmsg -> datalen = strlen ( data ) + 1 ; \\ idxmsg -> data\_position = db -> datmem\_cursor \\ idxmsg -> keylen = strlen ( key ) + 1 ; \\ strcpy ( idxmsg -> key , key ) ;\end{matrix}$$

in the embodiments of the present disclosure, datmem_cursor is an identifier of the data memory, which represents an end position of the valid data in the current datmem.

Fifth step: locating an end position of the index memory according to the index memory identifier, writing the value of the to-be-stored data into the end position of the index memory, and updating a value of the data memory identifier.

### The Above Steps May be Implemented by Following Codes:

$$\begin{matrix}char * datawrite = ( db -> datmen + idxmsg -> data\_position ) ; \\ strcpy ( datawrite , data ) ; \\ db -> datmem\_cursor = db -> datmem\_cursor + strlen ( data ) + 1 ;\end{matrix}$$

in addition, when performing the third step, the fourth step and the fifth step, the character string length needs to be increased by 1, because an additional character space is required to store a character ‘\0’.

The above is an endogenous security protection method for configuration data in an operating system of a network node provided by one or more embodiments of the present disclosure. Based on a same idea, the present disclosure also provides a corresponding endogenous security protection apparatus for configuration data in an operating system of a network node, as shown in FIG. 5.

FIG. 5 is a schematic diagram of an endogenous security protection apparatus for configuration data in an operating system of a network node provided by an embodiment of the present disclosure, where the apparatus is applied in a target unit, and the target unit is pre-deployed in the network node operating system of a white-box switch:
the target unit includes a command line input module, a distribution module, a judgment module, a synchronization module, a data backup module, at least three dynamic heterogeneous redundant executers, and a candidate executer to be brought online;
the apparatus includes:
the command line input module 300, configured to, when receiving a configuration command input by a user, encapsulate the configuration command into a network message flow, and send the network message flow to the distribution module and the data backup module respectively;
the data back-up module 302, configured to, when receiving the network message flow, parse the network message flow to obtain target configuration data, and store the target configuration data in the data backup module;
the distribution module 304, configured to, when receiving the network message flow, send the network message flow to each of the dynamic heterogeneous redundant executers, generate a distribution success message when distribution succeeds, and send the distribution success message to the synchronization module;
a target configuration data storage module 306, configured to, when each of the dynamic heterogeneous redundant executers receives the network message flow, parse the network message flow to obtain the target configuration data, and store the target configuration data;
the synchronization module 308, configured to, when receiving the distribution success message, read the target configuration data stored in the dynamic heterogeneous redundant executers respectively, and send the target configuration data stored in the dynamic heterogeneous redundant executers to the judgment module;
the judgment module 310, configured to: when receiving the target configuration data respectively stored in the dynamic heterogeneous redundant executers, perform consistency judgment according to the target configuration data respectively stored in the dynamic heterogeneous redundant executers, determine a judgment result, and return the judgment result to the synchronization module;
an online-offline scheduling module 312, configured to, when the synchronization module receives the judgment result, determine a target executer from the dynamic heterogeneous redundant executers according to the judgment result, take offline the target executer and clean the target executer, and bring online the candidate executer to be brought online, where the brought-online candidate executer reads the network message flow from the data backup module, and the target configuration data parsed from the network message flow is stored in the brought-online candidate executer; and
a configuration data take effect module 314, configured to, when the brought-online candidate executer stores the target configuration data, cause the synchronization module to synchronize the target configuration data stored in dynamic heterogeneous redundant executers in an online-state to the network node operating system, to cause the target configuration data take effect.

The present disclosure further provides a computer-readable storage medium, where the storage medium stores a computer program, and the computer program may be executed to implement the endogenous security protection method for configuration data in the network node operating system shown in FIG. 1.

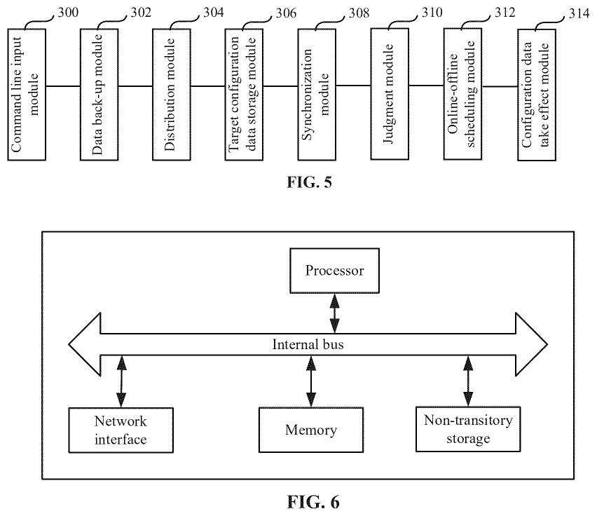

The present disclosure further provides an electronic device shown in a schematic structural diagram of FIG. 6. As shown in FIG. 6, with respect to hardware, the electronic device includes a processor, an internal bus, a network interface, a memory, and a non-volatile memory, and certainly may further include hardware required by another service. The processor reads a corresponding computer program from the non-volatile memory and then executes the computer program, to implement the endogenous security protection method for configuration data in the network node operating system shown in FIG. 2. Certainly, in addition to software implementation, other implementations, such as a logic device or a combination of software and hardware, are not excluded in the present disclosure, that is, the executing body of the following processing flow is not limited to each logic unit, and may also be hardware or a logic device.

In the 1990s, improvements to a technology can be clearly distinguished between improvements in hardware (e.g., improvements to circuit structures such as diodes, transistors, switches, etc.) or improvements in software (improvements to the method flow). However, with the development of technology, the improvement of many methods at present can be regarded as direct improvement of hardware circuit structure. Designers almost all get the corresponding hardware circuit structure by programming the improved method flow into the hardware circuit. Therefore, the improvement of a method flow cannot be realized by hardware entity modules. For example, a programmable logic device (PLD) (for example, a field programmable gate array (FPGA)) is an integrated circuit whose logic function is determined by programming the device by a user. A designer can program to “integrate” a digital system on a PLD without requiring a chip manufacturer to design and fabricate an application-specific integrated circuit chip. In addition, at present, instead of manually manufacturing an integrated circuit chip, this programming is also mostly implemented by using “logic compiler” software, which is similar to a software compiler used during program development and writing, and original code before compiling is also written in a specific programming language, which is referred to as a hardware description language (HDL), and there is not only one HDL, but many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., and the VHDL (Very-High-Speed Integrated Circuit Hardware Description Language) and Verilog are currently most commonly used. It should also be clear to those skilled in the art that the hardware circuit for implementing the logic method flow can be easily obtained only by slightly logically programming the method flow into an integrated circuit using the above several hardware description languages.

The controller may be implemented in any suitable manner, for example, the controller may take a form of, for example, a microprocessor or processor and a computer-readable medium storing computer-readable program code (e.g., software or firmware) executable by the (micro) processor, logic gates, switches, an application specific integrated circuit (ASIC), a programmable logic controller, and an embedded microcontroller, examples of which include, but are not limited to, the following microcontrollers: ARC 625D, Atmel AT91 SAM, Microchip PIC18 F26 K20, and Silicone Labs C8051 F320, and the memory controller may also be implemented as part of the control logic of the memory. Those skilled in the art will also appreciate that, in addition to implementing the controller in a purely computer readable program code, the method steps may be logically programmed to cause the controller to implement the same function in the form of logic gates, switches, application specific integrated circuits, programmable logic controllers, embedded microcontrollers, and the like. Therefore, such a controller may be considered as a hardware component, and a device for implementing various functions included in the controller may also be considered as a structure in the hardware component. Or even, an apparatus for implementing various functions may be considered to be both a software module for implementing a method and a structure within a hardware component.

The system, apparatus, module or unit illustrated in the above embodiments may be specifically implemented by a computer chip or an entity, or implemented by a product having a certain function. A typical implementation device is a computer. Specifically, the computer may be, for example, a personal computer, a laptop computer, a cellular telephone, a camera phone, a smartphone, a personal digital assistant, a media player, a navigation device, an email device, a game console, a tablet computer, a wearable device, or a combination of any of these devices.

For ease of description, the above apparatus is described by dividing functions into various units. Certainly, the functions of the units may be implemented in one or more pieces of software and/or hardware when implementing the present disclosure.

Those skilled in the art should understand that embodiments of the present disclosure may be provided as a method, system, or computer program product. Thus, the present disclosure may take the form of an entirely hardware embodiment, an entirely software embodiment, or an embodiment combining software and hardware aspects. Moreover, the present disclosure may take the form of a computer program product implemented on one or more computer usable storage media (including but not limited to magnetic disk storage. CD-ROM, optical storage, etc.) having computer usable program code embodied therein.

The present disclosure is described with reference to flowcharts and/or block diagrams of methods, devices (systems), and computer program products according to embodiments of the present disclosure. It should be understood that each process and/or block in the flowchart and/or block diagram, and a combination of processes and/or blocks in the flowchart and/or block diagram may be implemented by using computer program instructions. These computer program instructions may be provided to a processor of a general-purpose computer, a special-purpose computer, an embedded processor, or another programmable data processing apparatus to generate a machine, so that the instructions executed by the processor of the computer or another programmable data processing apparatus generate an apparatus for implementing functions specified in one or more processes in the flowchart and/or one or more blocks in the block diagram.

These computer program instructions may also be stored in a computer-readable memory capable of directing a computer or other programmable data processing apparatus to work in a specific manner, so that the instructions stored in the computer-readable memory generate an article of manufacture including an instruction apparatus, and the instruction apparatus implements functions specified in one or more processes in the flowchart and/or one or more blocks in the block diagram.

These computer program instructions may also be loaded onto a computer or other programmable data processing apparatus, so that a series of operation steps are performed on the computer or other programmable apparatus to generate a computer-implemented process, so that the instructions executed on the computer or other programmable apparatus provide steps for implementing functions specified in one or more processes in the flowchart and/or one or more blocks in the block diagram.

In a typical configuration, a computing device includes one or more processors (central processing unit. CPU), an input/output interface, a network interface, and a memory.

The memory may include a non-transitory memory, a random access memory (RAM), and/or a non-volatile memory in a computer-readable medium, for example, a read-only memory (ROM) or a flash RAM. The memory is an example of a computer-readable medium.

The computer-readable medium, including both permanent and non-permanent, removable and non-removable medium, may be implemented in information storage by any manner or technology. The information may be computer-readable instructions, data structures, modules of a program, or other data. Examples of computer storage medium include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape magnetic disk storage or other magnetic storage devices, or any other non-transmission medium that can be used to store information that can be accessed by a computing device. As defined herein, computer-readable medium does not include transitory computer-readable medium, such as modulated data signals and carrier waves.

It should also be noted that the terms “comprise.” “include.” or any other variant thereof are intended to cover a non-exclusive inclusion, so that a process, method, commodity, or device including a series of elements includes not only those elements, but also other elements not explicitly listed, or elements inherent to such process, method, commodity, or device. Without specific limitations, an element defined by the statement “including one” does not preclude the presence of another identical element in a process, method, article, or device that includes the element.

Those skilled in the art should understand that embodiments of the present disclosure may be provided as a method, system, or computer program product. Thus, the present disclosure may take the form of an entirely hardware embodiment, an entirely software embodiment, or an embodiment combining software and hardware aspects. Moreover, the present disclosure may take the form of a computer program product implemented on one or more computer usable storage media (including but not limited to magnetic disk storage. CD-ROM, optical storage, etc.) having computer usable program code embodied therein.

The present disclosure may be described in the general context of computer-executable instructions executed by a computer, such as program modules. Generally, program modules include routines, programs, objects, components, data structures, etc., that perform particular tasks or implement particular abstract data types. The present disclosure may also be practiced in distributed computing environments in which tasks are performed by remote processing devices connected through a communication network. In a distributed computing environment, program modules may be located in local and remote computer storage medium, including storage devices.

The embodiments in the present disclosure are described in a progressive manner, and the same and similar parts between the embodiments may refer to each other, and each embodiment focuses on differences from other embodiments. In particular, for the system embodiment, since it is substantially similar to the method embodiment, the description is relatively simple, and reference may be made to some descriptions of the method embodiment for related parts.

The above description is only an embodiment of the present disclosure, and is not intended to limit the present disclosure. Various modifications and variations are possible to those skilled in the art. Any modifications, equivalent substitutions, improvements, etc., made within the spirit and principle of the present disclosure shall fall within the scope of the claims of the present disclosure.

1. An endogenous security protection method for configuration data in an operating system of a network node, performed by a white-box switch equipped with the network node operating system, comprising:
receiving a configuration command input by a user, and encapsulating the configuration command into a network message flow;
backing up and parsing the network message flow to obtain target configuration data, and backing up the target configuration data;
storing the target configuration data in each of dynamic heterogeneous redundant executers of the network node operating system;
reading the target configuration data stored in the each of the dynamic heterogeneous redundant executers, and performing consistency judgment on the target configuration data stored in the each of the dynamic heterogeneous redundant executers to determine a judgment result;
determining a target executer from the dynamic heterogeneous redundant executers according to the judgment result, taking offline the target executer and cleaning the target executer, and bringing online a candidate executer;
reading, by the brought-online candidate executer, the backed-up network message flow, to store the target configuration data parsed from the network message flow in the brought-online candidate executer; and
after the brought-online candidate executer stores the target configuration data, synchronizing the target configuration data stored in dynamic heterogeneous redundant executers in an online-state to the network node operating system, to cause the target configuration data take effect.

2. The method according to claim 1, wherein backing up and parsing the network message flow to obtain the target configuration data, and backing up the target configuration data comprises:
creating and/or opening a database corresponding to a specified identifier, wherein the database corresponding to the specified identifier comprises: a hashlist describer table, an index memory, an index memory identifier, a data memory, and a data memory identifier;
parsing the network message flow to obtain the target configuration data, taking the target configuration data as to-be-stored data, and determining a key for the to-be-stored data;
determining a hash value for the key of the to-be-stored data;
searching, according to the hash value of the key of the to-be-stored data, a hashlist describer table of the database corresponding to the specified identifier, to obtain a hashlist describer corresponding to the key of the to-be-stored data, and determining, according to the hashlist describer corresponding to the key of the to-be-stored data, a target hashlist corresponding to the key of the to-be-stored data, wherein the target hashlist comprises index information for a plurality pieces of stored data; and
determining, according to the index information, whether the database corresponding to the specified identifier comprises the key of the to-be-stored data; and
when the database corresponding to the specified identifier does not comprise the key of the to-be-stored data, performing a data-adding action, wherein the data-adding action comprises updating the hashlist describer table, updating the index information in the index memory, and adding a value of the to-be-stored data in the data memory;
when the database corresponding to the specified identifier comprises the key of the to-be-stored data, performing a data-updating action, wherein the data-updating action at least comprises deleting the index information of original data in the index memory, deleting data information of the data memory, and updating the hashlist describer table.

3. The method according to claim 2, wherein determining, according to the index information, whether the database corresponding to the specified identifier comprises the key of the to-be-stored data comprises:
determining a location of a first item of the target hashlist in the index memory according to the hashlist describer corresponding to the key of the to-be-stored data;
wherein the target hashlist comprises index information for a plurality pieces of stored data, and the index information comprises a location of a next piece of stored data of each piece of stored data in the target hashlist in the index memory, a length of a value of each piece of stored data, a location of the value of each piece of stored data in the data memory, a length of a key of each piece of stored data, and content of the key of each piece of stored data;
traversing the index information of each piece of stored data comprised in the target hashlist, for the index information of each piece of stored data in the target hashlist, comparing content of a key of the piece of stored data in the index information of the piece of stored data with content of the key of the to-be-stored data; and
when the index information of the plurality pieces of stored data comprised in the target hashlist comprises a key of stored data having same content with the key of the to-be-stored data, determining the database corresponding to the specified identifier comprises the key of the to-be-stored data;
when the index information of the plurality pieces of stored data comprised in the target hashlist does not comprise a key of stored data having same content with the key of the to-be-stored data, determining the database corresponding to the specified identifier does not comprise the key of the to-be-stored data.

4. The method according to claim 2, wherein performing the data-adding action comprises:
determining, according to the hashlist describer corresponding to the key of the to-be-stored data, a target location of a first item of the target hashlist corresponding to the key of the to-be-stored data in the index memory;
creating a specified index information hashlist item, and inserting the specified index information hashlist item before the first item of the target hashlist;
obtaining a location of the value of the to-be-stored data in the data memory according to the data memory identifier;
updating a length of the value of the to-be-stored data, a position of the value of the to-be-stored data in the data memory, a length of the key of the to-be-stored data, and content of the key of the to-be-stored data into the specified index information hashlist item;
locating an end position of the index memory according to the index memory identifier, writing the value of the to-be-stored data into the end position of the index memory, and updating a value of the data memory identifier.

5. The method according to claim 2, wherein performing the data-updating action comprises:
taking stored data corresponding to a key of the stored data same as the key of the to-be-stored data in the database corresponding to the specified identifier as to-be-deleted data;
obtaining index information of the to-be-deleted data, determining a location of the index information of the to-be-deleted data in the target hashlist, and determining, according to the location of the index information of the to-be-deleted data in the target hashlist, whether the index information of the to-be-deleted data is located in a first item of the target hashlist;
when the index information of the to-be-deleted data is located in the first item of the target hashlist, updating index information of a next piece of stored data of the index information of the to-be-deleted data in the target hashlist into the hashlist describer table;
when the index information of the to-be-deleted data is located in a non-first item of the target hashlist, removing the index information of the to-be-deleted data from the target hashlist;
traversing the hashlist describer table, and updating describer information in the hashlist describer table to new describer information after data deletion;
traversing each hashlist table, and updating location information of a next item of each item in the hashlist table in the index memory to new location information after data deletion;
locating a deletion start node and a deletion end node of the index memory and the data memory respectively;
creating a temporary memory buffer, wherein the temporary memory buffer is configured to store original data in the index memory and the data memory respectively, and writing data, from which corresponding segments are deleted, back to the index memory and the data memory of the database respectively based on the deletion start node and the deletion end node.

6. The method according to claim 1, further comprising:
integrating a specified source code into a source code of an open networking operating system of the white-box switch in advance, compiling the integrated source code to obtain an image container, installing the image container in the white-box switch, and after the white-box switch is powered on and started, running an extension container corresponding to the image container in the network node operating system where the white-box switch is running; or,
publishing a developed extension container as an image container, and after the white-box switch is powered on and started, loading the image container into the network node operating system of the white-box switch.

7. The method according to claim 1, wherein the candidate executer is preset with an online protection period;
after reading, by the brought-online candidate executer, the backed-up network message flow, to store the target configuration data parsed from the network message flow in the brought-online candidate executer, the method further comprises:
determining, for each non-offline dynamic heterogeneous redundant executer, whether the target configuration data stored in the non-offline dynamic heterogeneous redundant executer is consistent with the target configuration data stored in the candidate executer within the online protection period, wherein the non-offline dynamic heterogeneous redundant executer is not within the online protection period; and
when the target configuration data stored in the non-offline dynamic heterogeneous redundant executer is inconsistent with the target configuration data stored in the candidate executer within the online protection period, taking the non-offline dynamic heterogeneous redundant executer offline.

8. (canceled)

9. A non-transitory computer-readable storage medium, storing a computer program, wherein when the computer program is executed by a processor, the method according to claim 1 is implemented.

10. An electronic device, comprising a memory, a processor, and a computer program stored in the memory and executable by the processor, wherein the processor executes the computer program to implement the method according to claim 1.
